(19) United States
(12) Patent Application Publication
(10) Pub. No.: US 2024/0205309 A1
(43) Pub. Date: Jun. 20, 2024

(54) METHOD AND ARCHITECTURE FOR SCALABLE OPEN RADIO ACCESS NETWORK (O-RAN) FRONTHAUL TRAFFIC PROCESSING

(71) Applicant: EdgeQ, Inc., Santa Clara, CA (US)

(72) Inventors: Sriram RAJAGOPAL, Karnataka (IN); Vishwanatha Tarikere BASAVARAJA, Karnataka (IN); Nikhil Prakash DUBEY, Maharashtra (IN); Deepak Kunnathkulangara PADMANABHAN, KERALA (IN)

(73) Assignee: EdgeQ, Inc., Santa Clara, CA (US)

(21) Appl. No.: 18/082,023

(22) Filed: Dec. 15, 2022

(51) Int. Cl. H04L 69/22; H04L 45/745; H04L 49/90; H04L 49/901

(52) U.S. Cl. CPC H04L 69/22; H04L 45/745; H04L 49/901; H04L 49/9031

(57) ABSTRACT

System and method embodiments are disclosed for scalable open radio access network (O-RAN) fronthaul traffic processing for distributed unit and radio unit. The system may be placed in an O-DU or an O-RU as a scalable O-RAN fronthaul traffic processing unit. O-RAN fronthaul traffic processing may be implemented in unified architecture with hardware-software (HW-SW) interaction in the form of Rx/Tx input descriptors and Rx/Tx output status descriptors. In the transmit direction, fronthaul packets are created with eCPRI header from a symbol memory where RB allocations are stored. In the receive path, from an ingress queues of Ethernet, resource block allocations are created and stored in the symbol memory. The discloses HW-SW interaction mechanism may be agnostic to cores of different architectures, support both RU and DU modes, and provides multiple transport encapsulation formats with scalability to meet various fronthaul traffic processing requirements.

### TECHNICAL FIELD

The present disclosure relates generally to wireless communication in an open radio access network (O-RAN). More particularly, the present disclosure relates to systems and methods for scalable O-RAN fronthaul traffic processing for distributed unit and radio unit.

### BACKGROUND

The importance of telecommunication in today's society is well understood by one of skill in the art. Advances in telecommunication have resulted in the ability of a communication system to support telecommunication at different levels, e.g., cell site, distributed unit (DU) site, etc.

A radio access network (RAN) is part of a telecommunication system. It implements a radio access technology (RAT) to provide connection between a device, e.g., a mobile phone, and a core network (CN). O-RAN is an approach based on interoperability and standardization of RAN elements including a unified interconnection standard for white-box hardware and open source software elements from different vendors.

As shown in FIG. 1 (“FIG. 1”), an ORAN comprises multiple radio units (RUS) 105, which are located near the antenna, multiple distributed units (DUs) 110, and a centralized unit (CU) 115 coupled to the multiple DUs via midhaul. The CU is connected to a core network (CN) 120 via Backhaul. DUs and RUs are connected by enhanced Common Public Radio Interface (eCPRI) based fronthaul through Ethernet links. The fronthaul needs to support high data rate with low latency connections demanded by many 5G multiple-input multiple-output (MIMO) and 4G applications. O-RAN fronthaul and eCPRI are evolving technologies, and their deployment scenarios are developing steadily. Existing network infrastructure and traditional fronthaul technologies are facing the challenges to address the increased demand and bandwidth.

Accordingly, what is needed are systems and methods for scalable O-RAN fronthaul traffic processing with improving efficiency and performance to support the developing deployment.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts different deployment scenarios for an O-RAN.

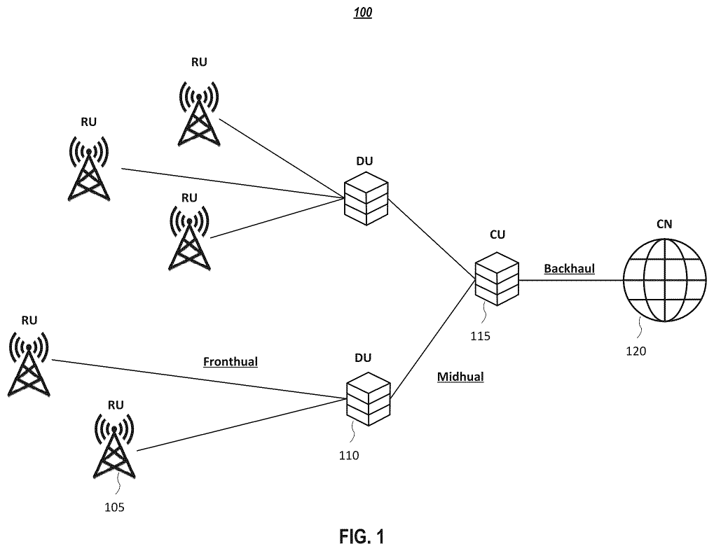

FIG. 2 depicts a block diagram for O-RAN and O-DU connection, according to embodiments of the present disclosure.

FIG. 3 depicts different O-DU and O-RU connection modes, according to embodiments of the present disclosure.

FIG. 4 depicts a split in functionalities between O-DU and O-RU, according to embodiments of the present disclosure.

FIG. 5 depicts an interaction of an O-DU or an O-RU with PHY and Ethernet link, according to embodiments of the present disclosure.

FIG. 6 depicts a system block diagram for O-RAN fronthaul traffic processing, according to embodiments of the present disclosure.

FIG. 7 depicts a block diagram for transmitting or receiving processing flow, according to embodiments of the present disclosure.

FIG. 8 depicts an overview for O-RAN fronthaul traffic processing with interactions with descriptors, according to embodiments of the present disclosure.

FIG. 9A depicts a first part of a detailed view for O-RAN fronthaul traffic processing with interactions with descriptors, according to embodiments of the present disclosure.

FIG. 9B depicts a second part of a detailed view for O-RAN fronthaul traffic processing with interactions with descriptors, according to embodiments of the present disclosure.

FIG. 9C depicts a third part of a detailed view for O-RAN fronthaul traffic processing with interactions with descriptors, according to embodiments of the present disclosure.

FIG. 10 depicts an exemplary Rx symbol address lookup table (LUT), according to embodiments of the present disclosure.

FIG. 11A depicts a process for O-RAN fronthaul traffic processing of control plane in a transmitting path, according to embodiments of the present disclosure.

FIG. 11B depicts a process for O-RAN fronthaul traffic processing of user plane in a transmitting path, according to embodiments of the present disclosure.

FIG. 12 depicts a process for O-RAN fronthaul traffic processing in a data-receiving path, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion, components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any examples are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” or “packet” shall not be interpreted as limiting embodiments of the present invention to 5G networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

### A. O-RAN Fronthaul Embodiments

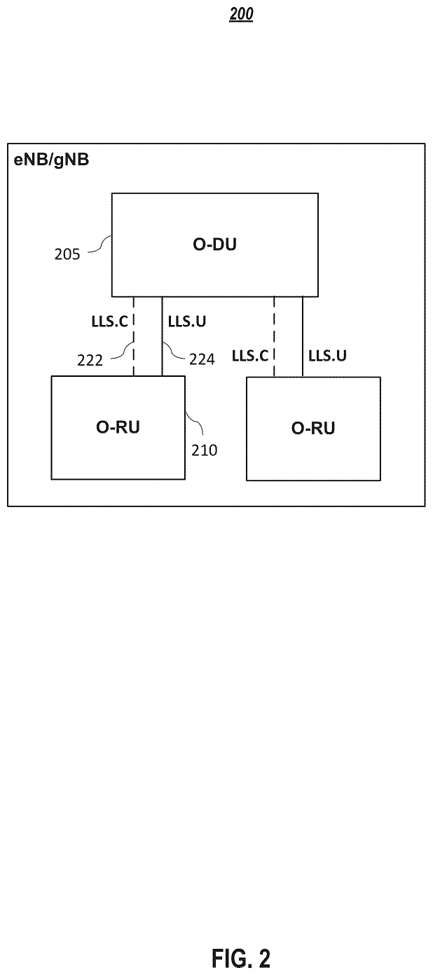

eCPRI-based fronthaul forms the foundation for next generation RAN technologies, including O-RAN. O-RAN envisages splitting the radio into two parts, an O-RAN DU (O-DU) 205 and multiple remote O-RAN RUs (O-RUs) 210 in a telecommunications node, such as a gNodeB (gNB) or an eNodeB (eNB), interconnected using high speed fronthaul links, as shown in FIG. 2. The fronthaul may also be referred to as lower layer split (LLS), which may comprise a control plane 222 for control message communication and a user plane 224 for user data communication.

eCPRI and O-RAN for 4g/5G/IoT places demands for high speed fronthaul with low latency, with high network bandwidth requirements. The eCPRI packet encapsulation and decapsulation on DU and RU require hardware acceleration to meet high performance demands with lowest latency.

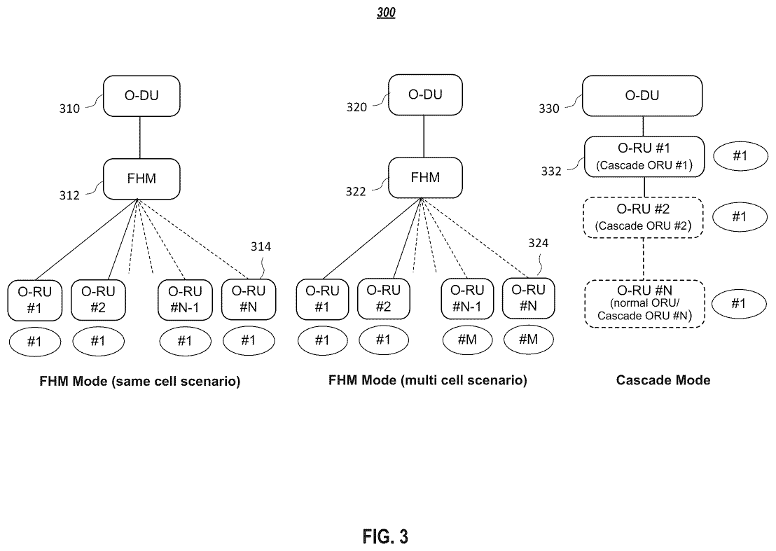

O-RAN supports the option of placing network functions (NFs) in different places along the signal path. That option, also referred to as a functional split, lets network engineers optimize performance and make tradeoffs. The function splits involves different 5G Protocol Stack layers, i.e. layer 1, layer 2 and layer 3. The 5G layer-1 (L1) is PHYSICAL Layer. The 5G layer-2 (L2) includes MAC, radio link control (RLC), and packet data convergence protocol (PDCP) sublayers. The 5G layer-3 (L3) is a radio resource control (RRC). FIG. 3 depicts different functional splits of an O-RAN. 3GPP has defined 8 functional split options for fronthaul networks in Technical Report 38.801 V 14.0.0 (2017-03) as below:
Option 1 (RRC/PCDP);
Option 2 (PDCP/RLC Split);
Option 3 (High RLC/Low RLC split, or Intra RLC split);
Option 4 (RLC-MAC split);
Option 5 (Intra MAC split);
Option 6 (MAC-PHY split);
Option 7 (Intra PHY split); and
Option 8 (PHY-RF split).

The O-RU converts radio signals sent to and from the antenna to a digital signal that can be transmitted over the fronthaul to an O-DU. The O-RU is a logical node hosting low PHY and RF processing based on a lower layer functional split. Function split option 7 divides into sub-options 7.1, 7.2, and 7.3, which vary in the way of dividing the PHY between the O-DU and the O-RU. Split Option 7.2 is adopted by O-RAN fronthaul specifications for splitting between high PHY residing in O-DU and low PHY residing in O-RU.

The DU is responsible for high L1 and low L2, which contains the data link layer and scheduling functions. The CU is responsible for high L2 and L3 (network layer) functions. For example, with an option 2 split, some L2 Ethernet functions may reside in the remote radio head (RHH).

The present patent document discloses embodiments of robust, high performance architecture with scalable hardware implementation to allow stacking of multiple hardware agents through a high speed network interconnect. The presented eCPRI fronthaul solution may be configured for hardware accelerator implementation to support DU/RU functionality required by eCPRI with minimal software intervention, Category A/B RUs with any functional split options per the O-RAN Standard, concurrent 4g LTE and 5g NR traffic, multiple numerologies of NR concurrently, Massive MIMO and Beamforming messaging, Layer 2 and Layer 3 encapsulation of eCPRI messages (Internet Protocol version 4 (IPv4), Internet Protocol version 6 (Ipv6), User Datagram Protocol (UDP), or Ethernet), multiple carriers per DU, multiple streams using multiple slices of the hardware, various Ethernet link speeds (e.g., 2.5/10/20/50G). Furthermore, the architecture is flexible enough to support future releases of eCPRI or O-RAN specifications.

O-DU and O-RU may be connected in different modes to form open networks, as shown in FIG. 3. O-DU and O-RU connection may be implemented using a fronthaul multiplexer (FHM) mode or a cascade mode. In the FHM mode, the O-DU 310 may connect, via an FHM 312, to multiple O-RUs 314 that are deployed on the same cell site; alternatively, the O-DU 320 may connect, via an FHM 322, to multiple O-RUs 324 on multiple cell sites (M cells as shown in FIG. 3). In the cascade mode, multiple O-RUs 332 are cascaded for connection to the O-DU 330. The FHM mode may be configured with LLS fronthaul support and function combination capability.

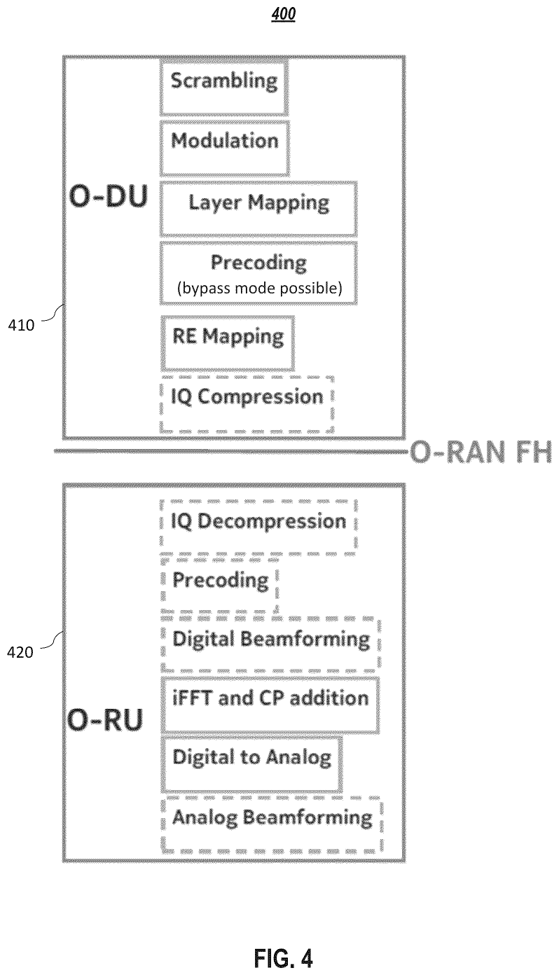

FIG. 4 depicts a split in functionalities between an O-DU and an O-RU, according to embodiments of the present disclosure. The O-DU 410 may be configured to implement functionalities comprising one or more of scrambling, modulation, layer mapping, precoding, remapping, IQ compression, etc. While the O-RU 420 may be configured to implement functionalities comprising one or more of IQ decompression, precoding, digital beamforming, inverse fast Fourier transformation (iFFT) and cyclic prefix (CP) addition, digital-to-analog conversion, analog beamforming, etc.

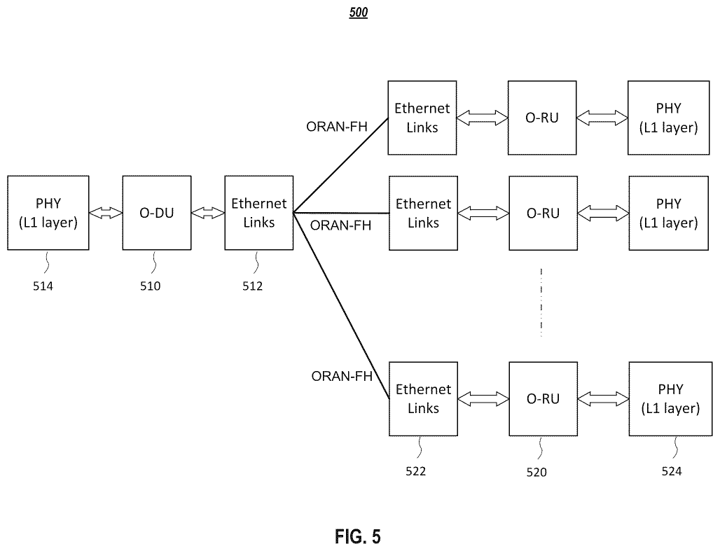

For O-RAN fronthaul, an O-DU or an O-RU has one side interacting with PHY (Layer1) 514 or 524 and the other side interacting with Ethernet link(s) 512 or 522, as shown in FIG. 5. The O-DU 510 acts as the master and controls the O-RU 520 through control plane (C-plane) messages. Although O-DU and O-RUs are shown in FIG. 5, one skill in the art shall understand that the O-DU may be a generic module encompassing functionalities for L2, L1, and eCPRI operations, and the O-RUs may be generic modules encompassing functionalities for L1, eCPRI and RF operations.

In a downlink direction, the O-DU 510 receives data samples (e.g., IQ data uncompressed or compressed by block floating point or modulation compression) from PHY 514 and sends the data samples out through the Ethernet egress queues as Ethernet packets via one or more O-DU Ethernet links 512. The Ethernet packets are received by one or more O-RUs 520 via corresponding O-RU Ethernet links 522. In an uplink path, the O-DU 510 controls the timing for receiving incoming Ethernet packets from each O-RU, extracts IQ data, and hands the extracted IQ data over to the PHY 514 for further processing. In a downlink path, the O-RUs 520 receives outgoing Ethernet packets sent from the O-DU 510 and extracts IQ data for further processing at corresponding PHY 524. Such downlink and uplink operation may be common for all physical channels, such as Physical Downlink Shared Channel (PDSCH), Physical Downlink Control Channel (PDCCH), Physical Broadcast Channel (PBCH), etc., for 4G LTE and 5G NR.

Given that most of the eCPRI packet processing and interfacing with Ethernet link and PHY are similar on both O-DU and O-RU sides, a unified architecture may be generated such communication. In this unified architecture, an O-DU may send C-plane messages to one or more O-RUs.

### B. Embodiments of Unified Architecture for O-RAN Fronthaul Traffic Processing

Described in the following sections are embodiments of a unified architecture for O-RAN fronthaul traffic processing. In one or more embodiments, the unified architecture may be implemented, in a nutshell, for one or more of:
in a transmit path, creating fronthaul packets with eCPRI header and IPV4/Ipv6/Ethernet header from a symbol memory where resource block (RB) allocation is stored;
in a receive path, creating required 4g/5g RB allocation from an incoming Ethernet ingress queue, and store the created RB allocation in the symbol memory;
in an O-DU mode, transmitting from an O-DU C-plane packets including beamforming weights; and
scaling according to data rate requirements by just adjusting O-RAN packet processing engine instances or Ethernet slices.

The unified architecture may adopt the same mechanism, firmware and hardware, to support both O-RU and O-DU modes with various transport encapsulation formats. The implementation may be memory mapped such that the mechanism may be introduced to any system supporting O-RAN fronthaul. The unified architecture may support different standards (e.g., LET and NR) simultaneously and different configurations for the same standard. For example, the unified architecture may support 2 carries of LTE and 3 carries of NR concurrently. The unified architecture may also support different sub-carrier spacing, e.g., 15 kHz, 30 kHz, or 60 kHz, for NR.

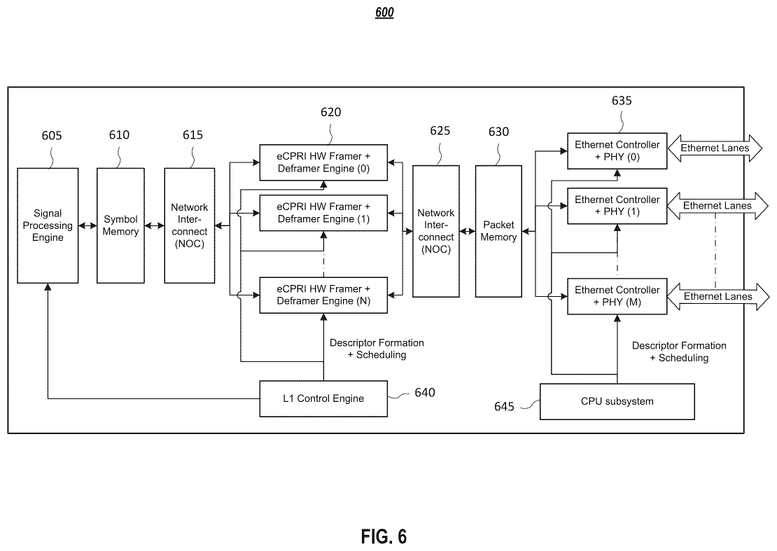

FIG. 6 depicts a system block diagram for O-RAN fronthaul traffic processing, according to embodiments of the present disclosure. The system may be placed in an O-DU or an O-RU as a scalable O-RAN fronthaul traffic processing unit 600. As shown in FIG. 6, the O-RAN fronthaul traffic processing unit comprises a signal processing engine (SPE) 605, a symbol memory 610, a first network interconnection interface 615, a plurality of eCPRI HW framer/deframer engines 620, a network interconnection interface 625, a packet memory 630, a plurality of Ethernet controller 635, an L1 control engine 640, and a microprocessor subsystem 645. The L1 control engine 640 couples to the SPE 605 for signal process scheduling and to the plurality of eCPRI HW framer/deframer engines 620 for descriptor formation and framing/deframing scheduling. Similarly, the microprocessor subsystem 645 Couples to the plurality of Ethernet controllers 635 for descriptor formation and Ethernet transmitting/receiving (Tx/Rx) scheduling. The O-RAN fronthaul traffic processing unit 600 performs various processing operations depending on process flow direction (receiving or transmitting).

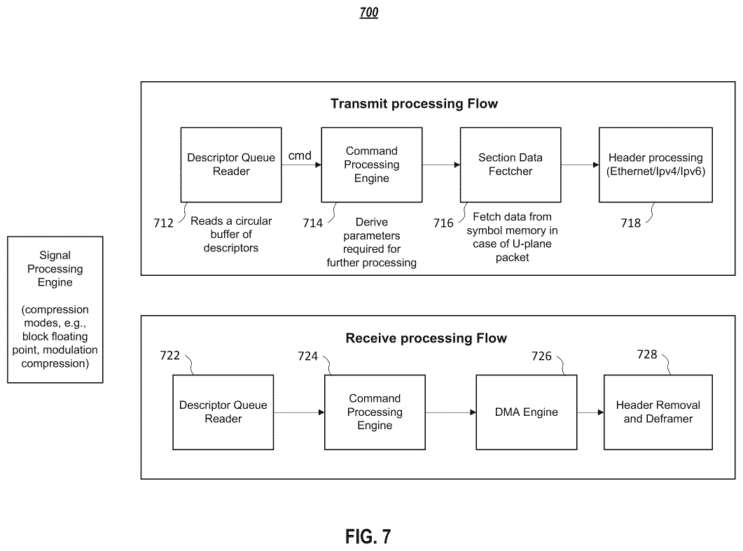

FIG. 7 depicts a block diagram for transmitting or receiving processing flow with respect to FIG. 6, according to embodiments of the present disclosure. In a transmitting path, a Tx descriptor queue reader 712 reads a descriptor buffer for Tx descriptors and outputs one or more Tx commands to a Tx command processing engine 714. The descriptor buffer may be a circular buffer to reduce storage, with a configurable buffer size. Descriptors, including Rx descriptors and Tx descriptors, are queued separately into the descriptor buffer by software. The Tx command processing engine 714 derives one or more parameters required for further Tx processing based on the one or more Tx commands. A data fetcher 716 fetches, based on the derived one or more parameters, one or more symbols from a symbol memory when one or more U-plane or user packets involved for Tx processing. A Tx header processing engine (framer) 718 adds O-RAN specific header to the one or more U-plane or user packets.

In a receiving path, an Rx descriptor queue reader 722 reads a descriptor buffer for Rx descriptors and outputs one or more Rx commands to an Rx command processing engine 724, which derives one or more parameters required for further Rx processing based on the one or more Rx commands. A direct memory access (DMA) engine 726 saves one or more Rx packets into a desired location in a packet memory based at least on the one or more parameters. Afterwards, an Rx header processing engine (deframer) 728 performs head removal and/or deframing operation for the saved one or more Rx packets.

In one or more embodiments, the Tx descriptor queue reader 712 and the Rx descriptor queue reader 722 may be the same descriptor queue reader that is configurable for performing Tx and Rx descriptor reading. The Tx header processing engine 718 and the Rx header processing engine 728 may be the same header processing engine that is configurable for performing header adding and header removal operations. In one or more embodiments, operations by the Tx descriptor queue reader 712, the Tx command processing engine 714, the data fetcher 716 fetches, and the Tx header processing engine (framer) 718 may be collectively performed by the eCPRI HW framer/deframer engines 620.

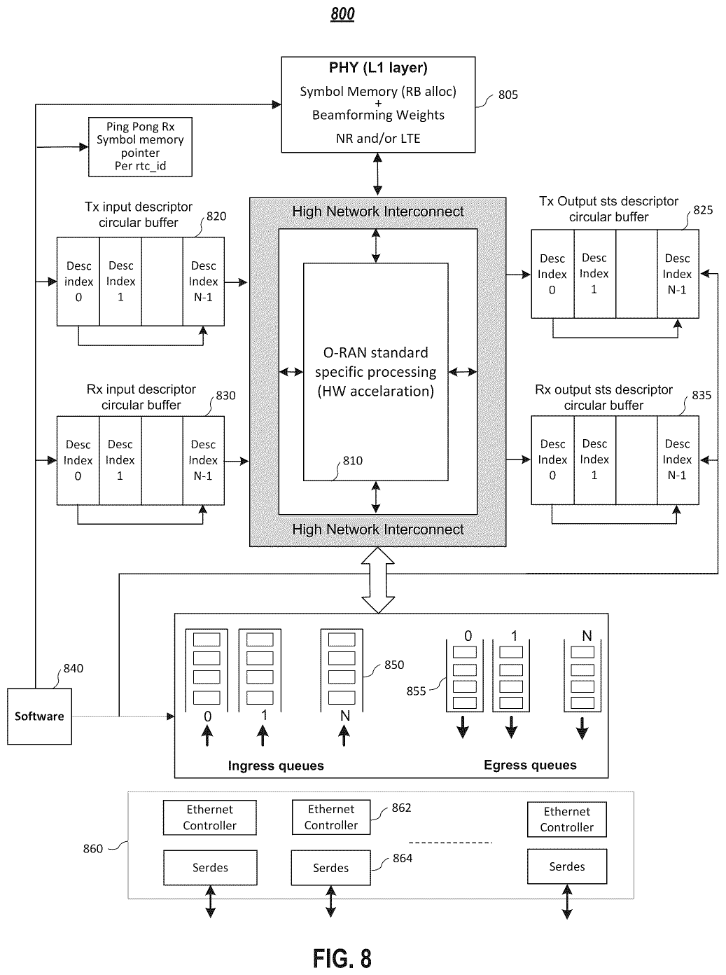

FIG. 8 depicts an overview for O-RAN fronthaul traffic processing with interactions with descriptors, according to embodiments of the present disclosure. One main hardware-software (HW-SW) interaction between HW acceleration component(s) 810 and a SW module 840 is implemented in the form of descriptors. Input descriptors may comprise Tx input descriptors and Rx input descriptors, which are separately stored a Tx input descriptor buffer 820 and an Rx input descriptor buffer 830. Output status descriptors may comprise Tx output status descriptors and Rx output status descriptors, which are separately stored in a Tx output status descriptor buffer 825 and an Rx output status descriptor buffer 835. In one or more embodiments, the Rx/Tx input descriptor buffers and the Rx/Tx output status descriptor buffers are circular buffers to reduce storage. The size of the circular buffers may be configurable by the software module 840. It shall be noted that the HW-SW interaction implementation may be agnostic to cores, which may be cores based on RISC, ARM, or x86 architecture.

In an Rx path, the HW acceleration component(s) 810 receives Rx packets that are queued in one or more ingress queues 850 from an Ethernet interface 860. The Ethernet interface 860 may comprise multiple Ethernet controllers with each Ethernet controller 862 controlling data transmission of a corresponding Serializer/Deserializer (SerDes) 864. In a Tx path, the HW acceleration component(s) 810 pushes Tx packets into one or more egress queues 855 for transmitting via the Ethernet interface 860. Furthermore, the HW acceleration component(s) 810 couples to a physical layer (PHY or L1) 805 for data receiving or transmission.

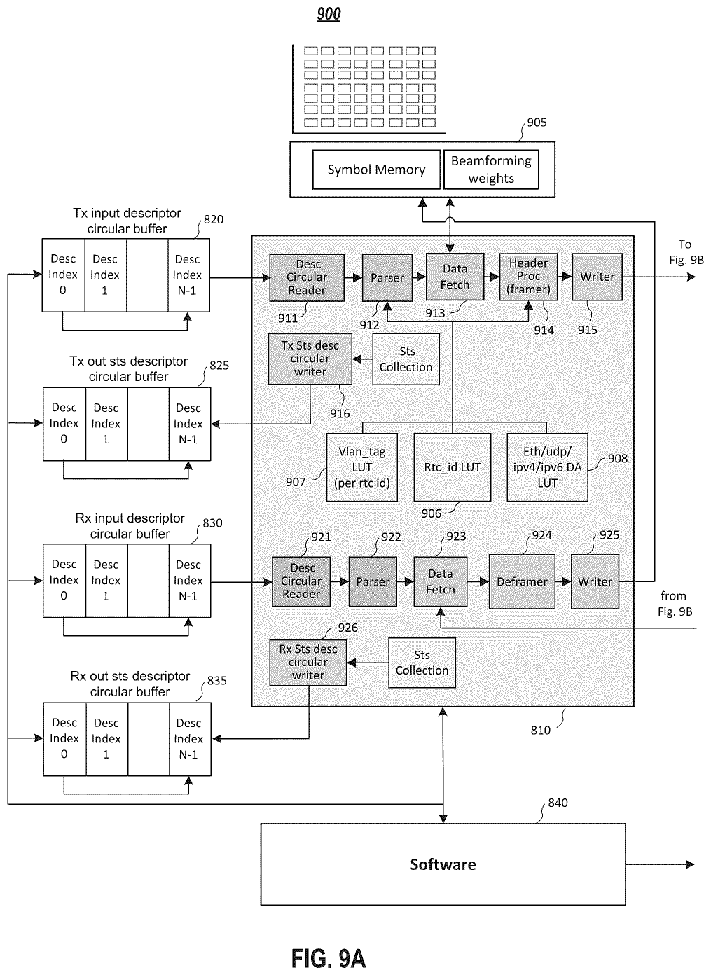

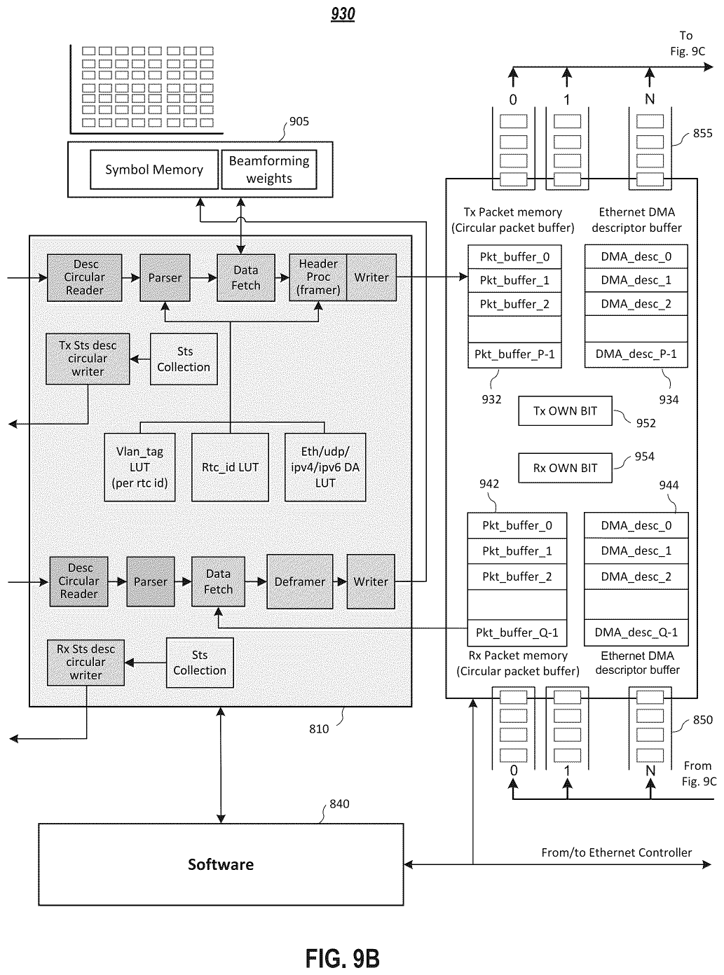

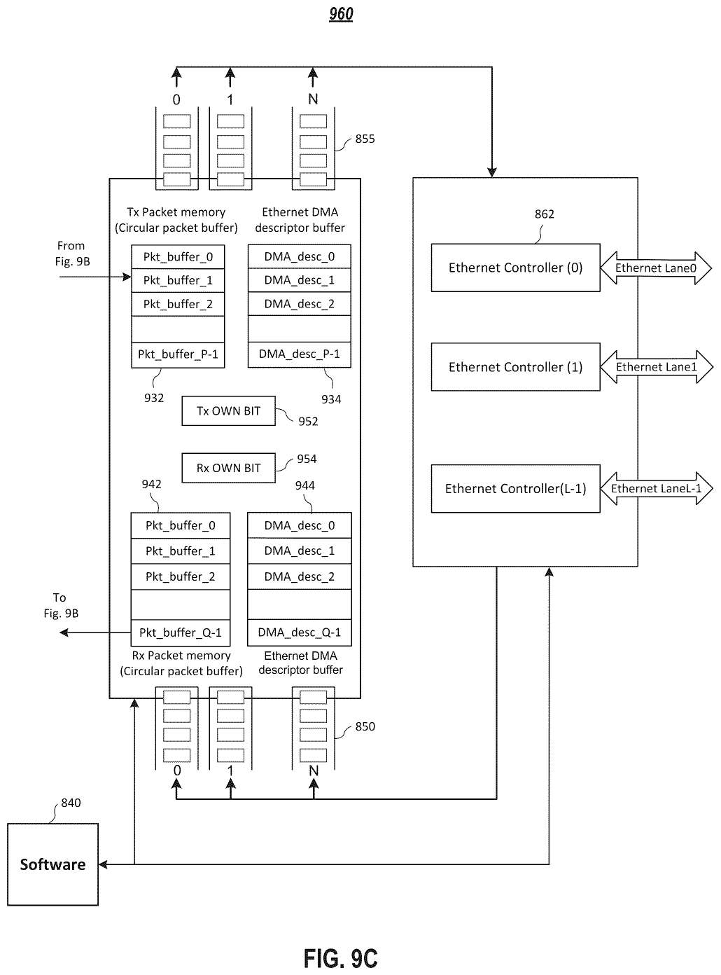

FIGS. 9A, 9B, and 9C collectively depict a detailed view for O-RAN fronthaul traffic processing with interactions with descriptors regarding the overview shown in FIG. 8, according to embodiments of the present disclosure. Tx and Rx input descriptors are respectively queued, by the software module 840, into the Tx input descriptor buffer 820 and the Rx input descriptor buffer 830. The HW acceleration component(s) 810 comprise a Tx input descriptor buffer reader 911 and an Rx input descriptor buffer reader 921, which respectively read Tx input descriptors and Rx input descriptors for subsequent ORAN-specific Tx or Rx processing.

In the Tx flow path, the read Tx input descriptors are parsed by a Tx parser 912 to generate one or more Tx instruction to a Tx data fetcher 913, which may fetch desired Tx data stored in a symbol memory. The desired Tx data may comprise user plane (U-plane) data and/or extension data, such as beamforming weights, attributes, or any other extensions. The fetched Tx data are processed by a framer 914 with O-RAN specific header added to form one or more frames. Afterwards, a Tx packet writer 915 queues the one or more Tx frames into a Tx packet memory 932, which may be a circular buffer. Upon a transmitting condition is triggered, a plurality of packets from the Tx packet memory 932 are pushed to one or more egress queues for transmitting, via one or more Ethernet controllers 862, through one or more Ethernet lanes or channels.

In the Rx flow path, the read Rx input descriptors are parsed by an Rx parser 922 to generate one or more Rx instruction to an Rx data fetcher 923, which fetches desired Rx data stored in a Rx packet memory 942, which may be a circular buffer. Rx data stored in the Rx packet memory 942 may be pushed from one or more ingress queues 850, to which Rx Ethernet frames received via the Ethernet interface 860 are queued. The fetched Rx data are processed by a deframer 924 to generate one or more deframed Rx data packets with O-RAN specific header removed. Afterwards, an Rx packet writer 925 writes the one or more deframed Rx data packets into the symbol memory 905.

Table 1 lists exemplary contents of a Tx input descriptor, which may comprise one or more of:
uplink or downlink;
Real-Time Control (RTC) identifier (RTC_ID);
control or data plane information;
frame, subframe, symbol, slot information;
timer match information;
user data compression header (udCompHdr);
payload length;
starting physical resource block (PRB) of data section description (start_prbc);
the number of continuous PRBs per data section description (Num_prbc);
extention_type; and
beam_ID for/beam compression.

TABLE 1
Exemplary contents of a Tx input descriptor
C/U plane ECPRI and APP Command Descriptor

| Name | bits # | | Description as per ORAN spec |
|---|---|---|---|
| Desc_type | 1 | LSB | 0 = ecpri command |
| Direction | 1 | | dataDirection |
| msg_type | 8 | | ecpriMessage 0x0 for U-plane message, |
| | | | 0x2 for C-plane messages |
| Version | 4 | | ecpriVersion |
| frame_ID | 8 | | frameID |
| subrframe_ID | 4 | | subframeId |
| slot_ID | 6 | MSB | slotId |
| | 32 | | |
| payloadlen | 16 | | ecpriPayload length |
| rtcid | 16 | | ecpriRtcid/ecpriPcid |
| | 32 | | |
| num_of_sections | 8 | | valid only for c plane msg |
| section_type | 8 | | valid only for c plane msg |
| timeoffset | 16 | | only for Section type = 0 & 3 |
| | 32 | | |
| frame_structure | 8 | | only for Section type = 0 & 3 |
| cpLength | 16 | | only for Section type = 0 & 3 |
| udcomphdr | 8 | | only for section type = 1 & 3 and direction = 1 |
| | 32 | | |
| Timing info | 32 | | Timer to indicate start of transmission w.r.t. to |
| | | | systimer |
| start_Symbol | 6 | | startSymbolid |
| filter_idx | 4 | | filterIndex |
| payload_ver | 3 | | payloadVersion |
| Reserved | 19 | | Reserved |
| C/U Plane Section descriptors | | | |
| Desc_type | 1 | | 1 = section command |
| sec_start | 1 | | Start of group of sections in a packet |
| sec_end | 1 | | End of a group of sections in a packet |
| num_prbc | 8 | | numPrbc |
| start_prbc | 10 | | startPrbc |
| sec_frag_len | 11 | | How much data to pull from a section |
| | | | descriptor(not used for now) |
| | 32 | | |
| sec_frag_buf_addr | 32 | | seg_frag_buf_addr (Assuming 273 × 28 = 7644 |
| | | | bytes per symbol) |
| | 32 | | |
| re_mask | 12 | | reMask |
| num_symbol | 4 | | numSymbol |
| ef | 1 | | ef |
| beam_id/comp hdr | 15 | | beamId for C-plane and udcomphdr for U-plane. |
| | | | BeamID is indexed to memory address. |
| | 32 | | |
| section ID | 12 | | sectionId |
| rb | 1 | | rb |
| sym_inc | 1 | | symInc |
| ef_extra | 1 | | Extensions other than Beamforming weights |
| ef_len | 16 | | Extension length |
| Reserved | 1 | | |
| | 32 | | |
| ef_addr | 32 | | Extension Address for extension data. |
| freq_offset | 24 | | Frequency Offset |
| mod_comp_en | 1 | | Enable modulation compression for this section. |
| mod_comp_iq_width | 4 | | Width of the I/Q sample post compression. |
| Reserved1 | 3 | | Reserved |

Table 2 lists exemplary contents of an Rx input descriptor, which may comprise one or more of:
buffer address (Buff-addr);
packet length:
packet status code; and
one or more non-eCPRI packets.

TABLE 2
Exemplary contents of an Rx eCPRI input descriptor
(eCPRI packets received from XGMAC)

| | bits # | Description |
|---|---|---|
| Buffer_addr_ptr | 32 | Address pointer in memory start of ecpri payload. Offseted to |
| | | the start of ecpri header. |
| Packet_length | 16 | length of the packet in memory |
| first_desc | 1 | first descriptor of the packet |
| last_desc | 1 | last descriptor of the packet (for jumbo packets) |
| abort | 1 | Abort or errored packet |
| non_ecpri | 1 | indicates non_ecpri_pkt |
| pkt_status_code | 3 | Indicates the status of packet in output descriptor. 0x0 for input |
| | | desc. |
| | | 0x0 - Packet accepted by window check. |
| | | 0x1 - Packet is early. |
| | | 0x2 - Packet is late. |
| | | 0x3 - UPlane packet accepted with window check bypassed. |
| | | 0x4 - CPlane packet accepted with window check bypassed. |
| | | 0x5 - Packet accepted as it belonged to untimed stream. |
| | | 0x6 - Window check triggered but packet was failed to be |
| | | recognized in any of the above categories. |
| | | 0x7 - No window check is done. |
| rsvd | 9 | rsvd |
| ddr_addr_low | 32 | ddr_addr |
| ddr_addr_high | 32 | |

In one or more embodiments, when the HW acceleration component(s) 810 implements ORAN-specific Tx or Rx processing, a Tx or Rx output status is collected. The Tx output status is written by a Tx output status writer 916 into the Tx output status buffer 825, which may be a circular buffer. The Rx output status is written by an Rx output status writer 926 into the Rx output status buffer 835, which may be a circular buffer. The Tx output status buffer 825 and the Rx output status buffer 835 are accessible by the software module 840 such that the Tx/Rx output status is known to the software module 840. When the Tx/Rx processing is completed, a Tx or Rx interruption signal may be generated and sent towards the software module 840.

In one or more embodiments, the O-RAN fronthaul traffic processing system may further comprises an Ethernet DMA descriptor buffer 934 for Tx and an Ethernet DMA descriptor buffer 944 for Rx flow. Both Ethernet DMA descriptor buffers 934 and 944 may be accessible by the software module 840 for DMA descriptor reading and/or writing.

For a Tx path, once the Tx processing is completed at HW acceleration component(s) 810, the software module 840 may create one or more Tx DMA descriptors, which are written into the Ethernet DMA descriptor buffer 934, and set the Tx ownership (own) bits 952 of the created DMA descriptors to a predetermined logic state (e.g., “1”). The own bit 952 indicates an owner ship of a DMA descriptor. When the own bit 952 is set (e.g., as “1”), it triggers pushing a plurality of packets from the Tx packet memory 932 to one or more egress queues for transmitting. Once the plurality of packets are pushed to the one or more egress queues, the Tx own bit 952 is cleared back to “0” such that the Tx processing may repeat.

For an Rx path, ingress Rx frames queued in one or more ingress queues 850 are saved in the Rx packet memory 942. The software module 840 creates one or more Rx DMA descriptors in the Ethernet DMA descriptor buffer 944, and clears the Rx own bits 954 of the created Rx DMA descriptors to logic “0”. Once the Ethernet DMA descriptor buffer 944 is read completely, the software module 840 queues one or more Rx input descriptors in the Rx input descriptor circular buffer 830 for Rx processing. When the HW acceleration component(s) 810 finishes the Rx processing, the Rx buffer writer 926 writes an Rx output status into the Rx output status buffer 835. Afterwards, the software module 840 sets the Rx own bits 954 of the created Rx DMA descriptors to logic “1”, such that the Rx processing may repeat.

### 1. Programmable Lookup Tables (LUTs)

In one or more embodiments, certain parameters related to fronthaul operation may be stored as LUTs in the memory which may be programmable or configurable. Such a setup makes the fronthaul operation highly configurable for various wireless applications. As shown in FIG. 9A, the LUTs may comprise different types of LUTs, such as a stream ID LUT 906, a virtual local area network (VLAN) tag LUT 907, a destination address LUT 908, and/or an Rx symbol address LUT, etc.

Stream ID LUT: Stream ID LUT may be used to configure the number of streams (RTC_ID) supported in fronthaul processing. The actual values of the RTC_ID which need to be supported may be stored in a stream ID LUT of depth N to support N streams. When an exemplary descriptor under processing has an RTC_ID value of 0x1234, the HW acceleration component(s) 810 checks if this RTC_ID value is present in the stream ID LUT. If yes, the HW acceleration component(s) 810 begins Tx or Rx processing for the stream.

VLAN tag LUT: VLAN tag is a field in an Ethernet frame header to identify VLAN belongings for packets in the Ethernet frame. The VLAN tag LUT may be configured to store one or more VLAN tags with each VLAN tag corresponding to an RTC_ID. Depending on an RTC_ID value in a descriptor under processing, a VLAN tag corresponding to the RTC_ID value may be fetched from the VLAN tag LUT for VLAN designation.

It shall be noted that the number of streams supported may be scalable. If the size of the VLAN tag LUT is increased, the number of streams which can be supported is also increase.

Destination address LUT for IPV4/Ipv6/UDP/Ethernet: The destination address (DA) in a corresponding Ethernet frame header is also configurable and may be stored in a programmable destination address LUT. The DA may have different address format for IPV4/Ipv6/UDP/Ethernet protocols.

Rx symbol address LUT:

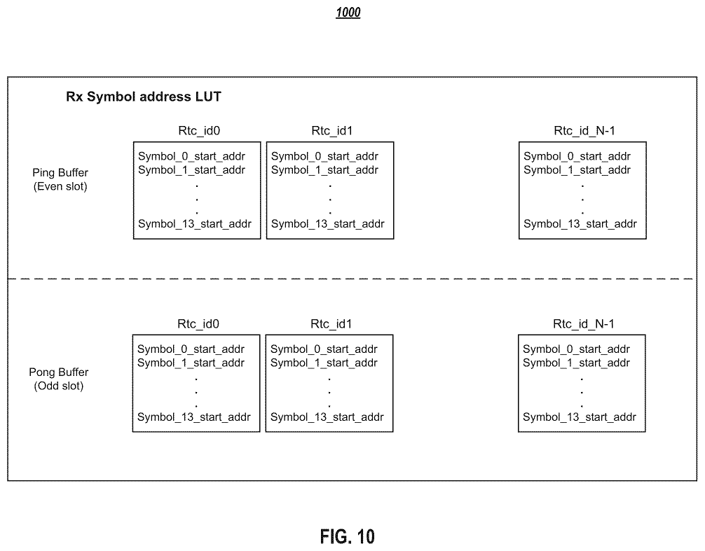

In the symbol memory accessible by an SPE, each symbol may need to be stored in a separate symbol buffer. Inside each symbol buffer, the RBs have to be stored in a continuous manner. In one or more embodiments of the present disclosure, a ping pong buffer per slot is adopted, with even slots going to one set of addresses and odd slots going to a completely different set of addresses, as shown in an exemplary Rx symbol address LUT in FIG. 10. The Rx symbol address LUT may be software-configurable. In an example for explanation, when an SPE is working on Slot0 samples, it is desired that Slot1 samples are not to overwrite Slot0 samples. Such a ping pong buffer configuration provides the SPE enough time for slot sample processing. The size of the Rx symbol address LUT may be configurable per stream ID. For example, when there are 64 streams for fronthaul processing, the Rx symbol address LUT may be configured to provide at least 64 sets of Ping buffers per slot to accommodate the 64 streams.

### 2. Process for Tx Flow Processing

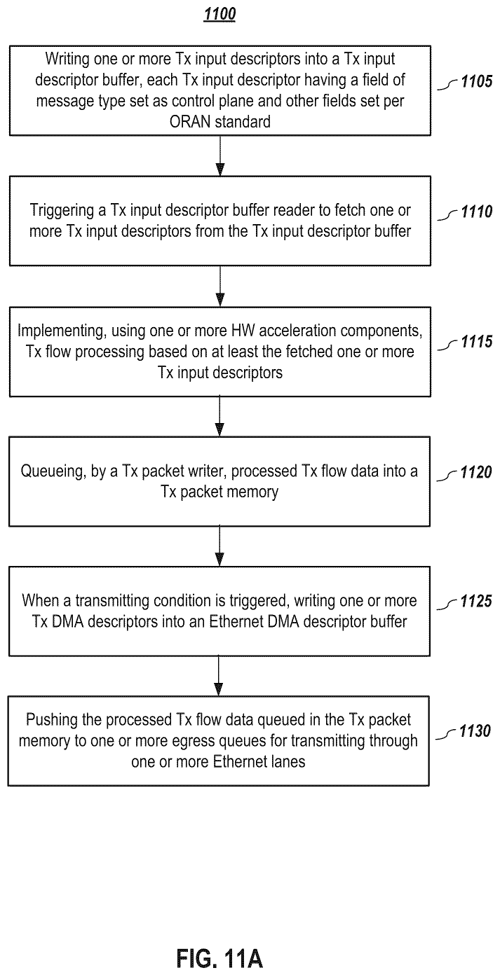

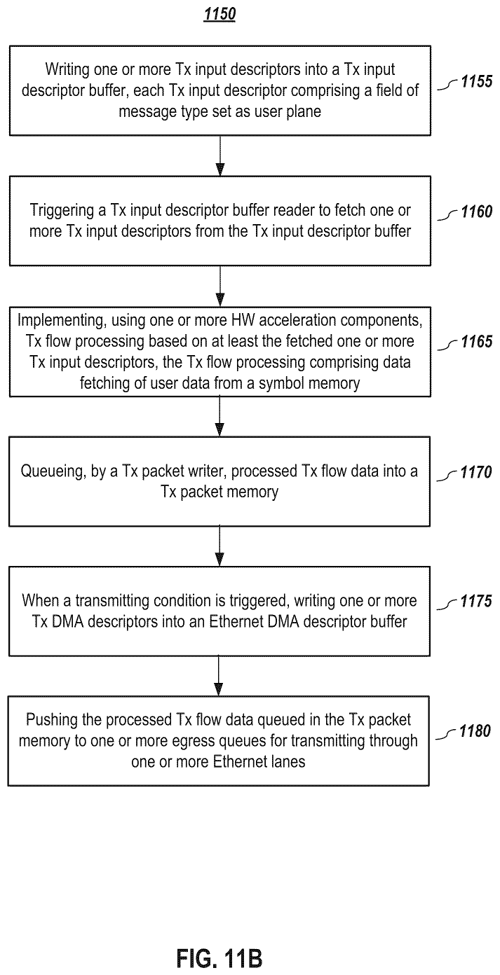

FIG. 11A depicts a process for O-RAN fronthaul traffic processing of control plane in a transmitting path, according to embodiments of the present disclosure. In step 1105, the software module writes one or more Tx input descriptors into a Tx input descriptor buffer, each Tx input descriptor comprising a field of message type set as control plane and other fields set per ORAN standard. In one or more embodiments, the software module may configure a total size of the Tx input descriptor buffer and fill a full or a subset of the Tx input descriptor buffer. In step 1110, the software module triggers a Tx input descriptor buffer reader to fetch one or more Tx input descriptors from the Tx input descriptor buffer.

In step 1115, one or more HW acceleration components implement Tx flow processing based on at least the fetched one or more Tx input descriptors. The Tx flow processing may comprise one or more of input descriptor parsing, data fetching, and frame forming as shown in FIG. 9A. In one or more embodiments, the fetched one or more Tx input descriptors may have an extension field (EF) as described by a specific O-RAN standard. When the EF field indicates presence of extensions (e.g., when EF field has a logic “1”), a Tx data fetcher fetches, from various or separate addresses, extension data, which may comprise beamforming weights, attributes, or any other extension. In one or more embodiments, the fetched one or more Tx input descriptors may also comprise a timer field to inform the one or more HW acceleration components the exact time for Tx processing.

In one or more embodiments, a status of the Tx flow processing is collected and written, by a Tx output status writer, to a Tx output status descriptor buffer. The Tx output status writer may write the status when the the Tx flow processing is complete or when the Tx input descriptor buffer is fully read.

In step 1120, a Tx packet writer 915 queues processed Tx flow data into a Tx packet memory. The Tx flow data may comprise one or more Tx frames. In step 1125, when a transmitting condition is triggered, the software module writes one or more Tx DMA descriptors into an Ethernet DMA descriptor buffer, and sets the Tx ownership (own) bits of the written DMA descriptors to a predetermined logic state (e.g., “1”). The transmitting condition may comprise one or more of the status of the Tx flow processing being written into the Tx output status descriptor buffer, an interrupt signal received at the software module indicting the completion of Tx flow processing.

In step 1130, the processed Tx flow data queued in the Tx packet memory are pushed to one or more egress queues for transmitting through one or more Ethernet lanes or channels. Once the Tx flow data in the one or more egress queues are transmitted and the Ethernet DMA descriptor buffer is fully read, the software module resets or clears the Tx own bit back to “0”, such that the Tx processing may repeat.

For user plane Tx processing, the process is similar to control plane Tx processing with a few exceptions, including user data fetching and insertion for Tx output frame. FIG. 11B depicts a process for O-RAN fronthaul traffic processing of user plane in a transmitting path, according to embodiments of the present disclosure. In step 1155, the software module writes one or more Tx input descriptors into a Tx input descriptor buffer, each Tx input descriptor comprising a field of message type set as user plane, a field (start_prbc) to define a starting physical resource block (PRB) of data section description, and a field (Num_prbc) to define the number of continuous PRBs per data section description.

In step 1160, the software module triggers a Tx input descriptor buffer reader to fetch one or more Tx input descriptors from the Tx input descriptor buffer. In step 1165, one or more HW acceleration components implement Tx flow processing based on at least the fetched one or more Tx input descriptors. The Tx flow processing may comprise one or more of input descriptor parsing, data fetching of user data from a symbol memory, and frame forming as shown in FIG. 9A.

In step 1170, a Tx packet writer 915 queues processed Tx flow data into a Tx packet memory. The Tx flow data may comprise one or more Tx frames. In step 1175, when a transmitting condition is triggered, the software module writes one or more Tx DMA descriptors into an Ethernet DMA descriptor buffer, and sets the Tx ownership (own) bits of the written DMA descriptors to a predetermined logic state (e.g., “1”). In step 1180, the processed Tx flow data queued in the Tx packet memory are pushed to one or more egress queues for transmitting through one or more Ethernet lanes or channels.

### 3. Process for Rx Flow Processing

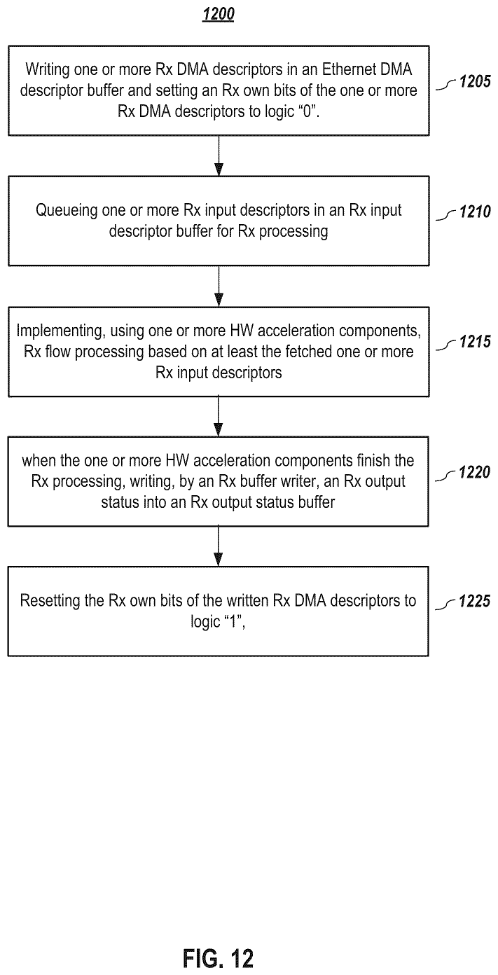

Although Rx flow processing is in an opposite path to the Tx processing, the Rx flow processing may still be implemented using similar interaction between HW acceleration component(s) and a SW module in the form of descriptors. FIG. 12 depicts a process for O-RAN fronthaul traffic processing in a data-receiving path, according to embodiments of the present disclosure. In step 1205, the software module writes one or more Rx DMA descriptors in an Ethernet DMA descriptor buffer, and sets the Rx own bits of the one or more Rx DMA descriptors to logic “0”. In step 1210, once the Ethernet DMA descriptor buffer is read completely, the software module queues one or more Rx input descriptors in an Rx input descriptor buffer for Rx processing.

In step 1215, one or more HW acceleration components implement Rx flow processing based on at least the fetched one or more Rx input descriptors. The Rx flow processing may comprise one or more of input descriptor parsing, data fetching, deframing and Rx packet writing, as shown in FIG. 9A. In one or more embodiments, data fetching comprise fetching one or more Rx frames stored in an Rx packet memory. Rx frames stored in the Rx packet memory are pushed from one or more ingress queues, to which Rx Ethernet frames received via the Ethernet interface are queued. The fetched one or more Rx frames are processed by a deframer to generate one or more deframed Rx data packets with O-RAN specific header removed. Afterwards, an Rx packet writer writes the one or more deframed Rx data packets into the symbol memory.

In one or more embodiments, a status of the Rx flow processing is collected and written, by an Rx output status writer, to an Rx output status descriptor buffer. The Rx output status writer may write the status when the the Rx flow processing is complete or when the Rx input descriptor buffer is fully read.

In step 1220, when the one or more HW acceleration components finish the Rx processing, an Rx buffer writer writes an Rx output status into an Rx output status buffer. In step 1225, the software module resets the Rx own bits of the written Rx DMA descriptors to logic “1”, such that the Rx processing may repeat.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A method for open radio access network (O-RAN) fronthaul traffic processing comprising:
writing one or more transmitting (Tx) input descriptors into a Tx input descriptor buffer, each Tx input descriptor having one or more fields;
fetching, by a Tx input descriptor buffer reader, one or more Tx input descriptors from the Tx input descriptor buffer;
implementing, using one or more acceleration components, Tx flow processing based on at least the fetched one or more Tx input descriptors;
queueing, by a Tx packet writer, processed Tx flow data into a Tx packet memory; and
pushing the processed Tx flow data queued in the Tx packet memory to one or more egress queues for transmitting through one or more Ethernet lanes.

2. The method of claim 1, wherein the one or more fields comprise a field of message type set as control plane and other fields set per ORAN standard, the ORAN standard for 5G NR or 4G LTE.

3. The method of claim 1, wherein the one or more fields comprise a field of message type set as user plane, a field to define a starting physical resource block (PRB) of data section description (start_prbc), and a field to define the number of continuous PRBs per data section description (Num_prbc).

4. The method of claim 1, wherein the Tx input descriptor buffer is a circular buffer.

5. The method of claim 1, wherein the Tx flow processing is tracked, a Tx output status is written by a Tx output status writer into a Tx output status buffer.

6. The method of claim 1, wherein implementing, using one or more acceleration components, Tx flow processing comprising:
parsing, using a Tx parser, the fetched one or more Tx input descriptors to generate one or more Rx instructions;
fetching, using a Tx data fetcher, Tx data stored in a symbol memory; and
processing, using a framer, the fetched Tx data with O-RAN specific header added to form one or more Tx frames.

7. The method of claim 6, wherein the fetched Tx data comprising one or more of:
user data;
beamforming weights; and
extension data.

8. A method for open radio access network (O-RAN) fronthaul traffic processing comprising:
writing one or more receiving (Rx) direct memory access (DMA) descriptors in an Ethernet DMA descriptor buffer;
queueing one or more Rx input descriptors in an Rx input descriptor buffer;
implementing, using one or more acceleration components, Rx flow processing based on at least the fetched one or more Rx input descriptors; and
writing, by an Rx buffer writer, an Rx output status into an Rx output status buffer when the one or more acceleration components finish the Rx processing.

9. The method of claim 8, wherein the Rx input descriptor buffer and the Rx output status buffer are circular buffers.

10. The method of claim 8 further comprising:
setting an Rx own bits of the one or more Rx DMA descriptors to logic “0” when the one or more Rx DMA descriptors are written in the Ethernet DMA descriptor buffer; and
resetting the Rx own bits of the written Rx DMA descriptors to logic “1” after the one or more acceleration components finish the Rx processing.

11. The method of claim 8, wherein implementing, using one or more acceleration components, Rx flow processing comprising:
parsing, using a Rx parser, the fetched one or more Tx input descriptors to generate one or more Rx instructions;
fetching, using a Rx data fetcher, Rx data stored in an Rx packet memory; and
processing, using a deframer, the fetched Rx data with O-RAN specific header removed.

12. The method of claim 11, wherein the Rx data stored in an Rx packet memory are pushed from one or more ingress queues, to which one or more Rx Ethernet frames received from an Ethernet interface are queued.

13. A system for open radio access network (O-RAN) fronthaul traffic processing comprising:
an Ethernet interface to transmit or receive Ethernet frames, the Ethernet interface comprises a transmitting (Tx) packet memory, a receiving (Rx) packet memory, a Tx Ethernet direct memory access (DMA) descriptor buffer, and an Rx Ethernet DMA descriptor buffer;
a symbol memory storing resource block (RB) allocations; and
one or more acceleration components implementing Tx flow processing, Rx flow processing, or a combination of both Tx and Rx flow processing, with hardware-software (HW-SW) interaction in the form of input descriptors and output status descriptors, the one or more acceleration components comprise:
a Tx input descriptor buffer reader that fetches, from a Tx input descriptor buffer, one or more Tx input descriptors for Tx flow processing based on at least the fetched one or more Tx input descriptors; and
a Tx output status writer that writes a Tx output status regarding the Tx flow processing into a Tx output status buffer;
a Rx input descriptor buffer reader that fetches, from a Rx input descriptor buffer, one or more Rx input descriptors for Rx flow processing based on at least the fetched one or more Rx input descriptors; and
a Rx output status writer that writes a Rx output status regarding the Rx flow processing into a Tx output status buffer.

14. The system of claim 13, wherein the Tx input descriptor buffer, the Tx output status buffer, the Rx input descriptor buffer, and the Rx output status buffer are circular buffers.

15. The system of claim 13, wherein the one or more acceleration components further comprise:
a Tx parser that parses the fetched one or more Tx input descriptors to generate one or more Tx instructions;
a Tx data fetcher that fetches Tx data stored in the symbol memory;
a framer that processes the fetched Tx data with O-RAN specific header added to form one or more Tx frames; and
a Tx packet writer that queues the one or more Tx frames into the Tx packet memory.

16. The system of claim 13, wherein the one or more acceleration components further comprise:
a Rx parser that parses the fetched one or more Rx input descriptors to generate one or more Rx instructions;
a Rx data fetcher fetches desired Rx data stored in the Rx packet memory; and
a deframer that processes the fetched Rx data to generate one or more deframed Rx data packets with O-RAN specific header removed; and
an Rx packet writer that writes the one or more deframed Rx data packets into the symbol memory.

17. The system of claim 13, wherein the HW-SW interaction is be agnostic to cores of different architectures.

18. The system of claim 13, wherein the system is deployable in an O-DU or an O-RU as a scalable O-RAN fronthaul traffic processing unit, which is scalable to increase carrier handling capacity by replicating partition of the HW-SW interaction as desired.

19. The system of claim 18, wherein the scalable O-RAN fronthaul traffic processing unit is capable of supporting different configurations comprising different symbol rates and/or subcarrier spacings.

20. The system of claim 13, wherein the one or more acceleration components comprises one or more configurable lookup tables (LUTs) to store one or more parameters relevant for fronthaul operation, the one or more LUTs comprise at least one of:
a stream ID LUT to store the number of streams (RTC_ID) supported in fronthaul processing;
a virtual local area network (VLAN) tag LUT to store one or more VLAN tags with each VLAN tag corresponding to an RTC_ID;
a destination address LUT to store header information of IPv4/Ipv6/User Datagram Protocol (UDP)/Ethernet protocols; and
an Rx symbol address LUT.
